(19) United States
(12) Patent Application Publication
(10) Pub. No.: US 2023/0001649 A1
(43) Pub. Date: Jan. 5, 2023

(54) APPARATUS AND METHOD FOR CUTTING AND JOINING A SHEET ELEMENT TO A CONTAINER

(71) Applicant: SARONG SOCIETA' PER AZIONI, Reggiolo (Reggio Emilia) (IT)

(72) Inventors: Andrea BARTOLI, Ameglia (La Spezia) (IT); Davide CAPITINI, Ameglia (La Spezia) (IT)

(21) Appl. No.: 17/782,287

(22) PCT Filed: Dec. 16, 2020
(86) PCT No.: PCT/IB2020/062028

§ 371 Date: Jun. 3, 2022

(30) Foreign Application Priority Data
Dec. 18, 2019 (IT) 102019000024571

(51) Int. Cl. B29C 65/74; B29C 65/08; B29C 65/00; B65B 61/06; B65B 29/02; B65B 7/16; B65B 51/22

(52) U.S. Cl. CPC B29C 65/745; B29C 65/08; B29C 66/344; B29C 66/81431; B29C 66/5326; B29C 66/1122; B29C 66/851; B65B 61/06; B65B 29/022; B65B 7/164; B65B 51/225; B29L 2031/712

(57) ABSTRACT

An apparatus for cutting off and joining a sheet element to a container includes an operating unit including a cutting device with a cutting edge surrounding a joining device. The operating unit and the container are movable with respect to one another along a movement axis between a spaced condition, in which a sheet material is interposed therebetween and is spaced therefrom, and a joined condition, in which the joining device joins the material to the container. A retaining device retains the material during joining and cutting. In the joined condition, the cutting device remains fixed relative to the joining device and the retaining device moves along the axis from tensioning to cutting positions, the sheet element being cut on the cutting edge from the material during movement of the retaining device from the tensioning to the cutting positions.

The present invention relates to an apparatus and a method for cutting off and joining a sheet element to a container.

In particular, the present invention finds advantageous application in an apparatus and in the relative method for cutting off and joining a sheet element, such as a closing element, to a base wall of a casing of a container such as a capsule for beverages as well as for cutting off and joining a sheet element, such as a covering element, to a flanged edge of the casing, to which reference will be made without losing generality.

Containers for food products which are sealed so as to hermetically contain the product, at the same time extending the life time thereof and maintaining the organoleptic properties thereof are known.

Among them, capsules for beverage that can be used on automatic dispensing machines are increasingly widespread.

These capsules are disposable and single-dose containers comprising an outer casing in the shape of a glass or cup. The casing usually has a base wall and a side wall defining an open cavity that can contain the initial product, for example ground coffee or tea, from which the final product, for example the beverage, is obtained.

A flanged edge extends radially from the side wall and is arranged around the open cavity, on the opposite side with respect to the base wall. The cavity is hermetically closed by a covering element, fixed to the flanged edge, so as to seal the initial product inside the container.

The base wall of the capsule can have an opening delimited by an edge region to which a closing element can be fixed.

The base wall of the capsule can also have a central region, and a groove, interposed between the edge region and the central region. The central region and the edge region can extend on respective planes which are offset with respect to each other along a longitudinal axis of the capsule and, in this case, the closing element can be fixed to the edge region and to the central region on different planes.

The capsule must be pierceable to allow the introduction of liquid under pressure, typically water, and the delivery of the coffee beverage obtained.

For example, the capsule can be used in a dispensing machine in which the closing element is pierceable by an injection device of the dispensing machine, which can have piercing blades shaped so to be housed in the groove, and wherein the covering element is pierceable by an extraction device.

Both the covering element and the closing element are produced by means of a pierceable sheet element, so that the capsule can be used with great flexibility of use in the dispensing machines of interest.

Cutting off and joining apparatuses are known in order to produce the capsule, that is, to fix the covering element to the base wall and to fix the covering element to the flanged edge and which are configured to cut off the sheet element from a sheet material and subsequently to join the cut off element to the respective wall to which it is to be applied.

The sheet material is usually fed by a web wound on a reel and is flexible in the sense that it is a thin film, for example of a compostable material or of aluminium.

The apparatus may comprise an operating unit comprising a joining device and a cutting device, the cutting edge of which surrounds the joining device. In particular, the joining device and the cutting device can be tubular and can be arranged coaxial with respect to a movement axis with respect to which the operating unit and the container can move between a spaced condition, in which the sheet material is interposed therebetween and is spaced therefrom, and a joined condition, in which the joining device is configured to join the sheet material to the container.

The cutting device can be configured to translate together with the joining device along the movement axis and to translate also with respect to the joining device with respect to this axis.

In a first step, the operating unit and the container can be in a spaced condition, in order to be able to interpose the sheet material therebetween.

In a second step, the cutting device can be advanced through the sheet material to cause the cutting edge to cut the sheet element. At the end of the cut, the cut off sheet element remains blocked inside the cutting device.

In a third step, the joining device can be advanced to accompany the cut element by guiding it until it engages with the wall of interest to which it is to be joined. The joining device can subsequently join the cut element, for example, by heat sealing or by ultrasonic welding.

The join of the sheet element to the container by means of the apparatus and the method described above can be imprecise if the sheet element, retained inside the tubular cutting device, does not remain in the ideal position but moves, given the flexibility and the consistency of the sheet material itself. If the sheet element is joined imprecisely to the container wall, the resulting container is defective and must be discarded as it cannot be used.

Cutting off and joining apparatuses forming part of the state of the art are known and are cited hereinafter by way of example.

Document US 2004/206048 shows an apparatus for sealing containers which comprises a welding head for welding a peripheral edge portion of a lid to an internal surface of a tapered body of a container. The welding head is provided with a face that can be inserted inside said internal surface.

Document CN 108454973 discloses a film processing method and apparatus comprising pressing, cutting and welding in which the apparatus comprises a punching and welding device comprising a punching tool and a heated head, wherein the heated head is installed in a movable manner in the punching tool.

Document DE 102007027389 shows a method for welding a film to an opening of a container.

Document DE 102016218218 shows a unit for connecting two parts and forming a container, wherein the device comprises a matrix and a pressing device and is provided with a cutting punch and a welding punch.

The object of the present invention is to provide an apparatus and a method for cutting off and joining a sheet element to a container which solves the problems of the prior art.

Still another object of the present invention is to provide an apparatus and a method for cutting off and joining a sheet element to a container by means of which it is possible to obtain containers of good quality which have a sheet element placed in the correct position.

A further object of the present invention is to provide an apparatus and a method for cutting off and joining a closing element to a casing of a capsule for beverages which guarantees a correct cutting off of the closing element from a sheet material and also a correct joining of the closing element to a base wall of the casing of the capsule.

These tasks are achieved by a cutting off and joining apparatus and method in accordance with the present invention, comprising the technical characteristics set out in one or more of the appended claims.

Further characteristics and advantages of the present invention will become more apparent from the approximate and thus non-limiting description of a preferred, but not exclusive, embodiment of a cutting off and joining apparatus and method, as illustrated in the accompanying drawings, in which:

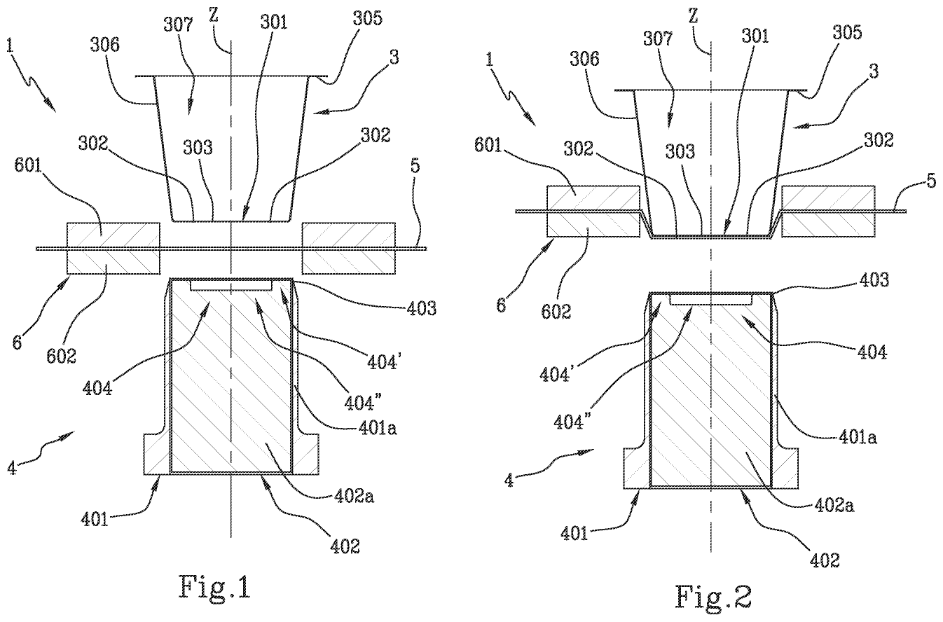

FIG. 1 is a schematic sectional view of an apparatus for cutting and joining a sheet element to a wall of a container, for example to an edge region of a base wall of a casing of a capsule for beverages, in a non-operating step, in which the apparatus comprises an operating unit and a container which are in a spaced condition, and a retaining device, which is in a non-operating position and is configured to retain a sheet material interposed between the operating unit and the container;

FIG. 2 is a schematic sectional view of the apparatus of FIG. 1, in a preparation step, in which the operating unit and the container are in the spaced condition of FIG. 1, the operating unit comprises a joining device and a cutting device, the retaining device being in a tensioning position in which the sheet material is moved away from a cutting edge of the cutting device;

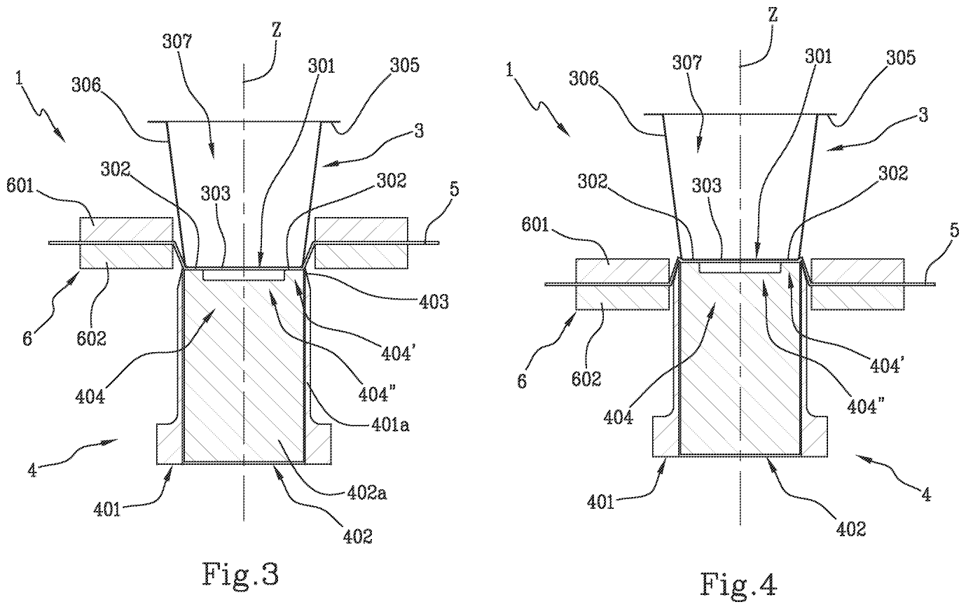

FIG. 3 is a schematic sectional view of the apparatus of FIG. 1, in a joining step, subsequent to the preparation step, in which the operating unit and the container are in a joined condition in which the joining device joins the sheet material to the container, and the retaining device is in the tensioning position of FIG. 2;

FIG. 4 is a schematic sectional view of the apparatus of FIG. 1, in an initial cutting step, subsequent to the joining step, in which the operating unit and the container are in the joined condition in which the joining device continues to join the sheet material to the container and the retaining device is in an initial cutting position, in which the sheet element begins to be cut on the cutting edge of the cutting device as it intercepts it, during the movement of the retaining device from the tensioning position to the initial cutting position;

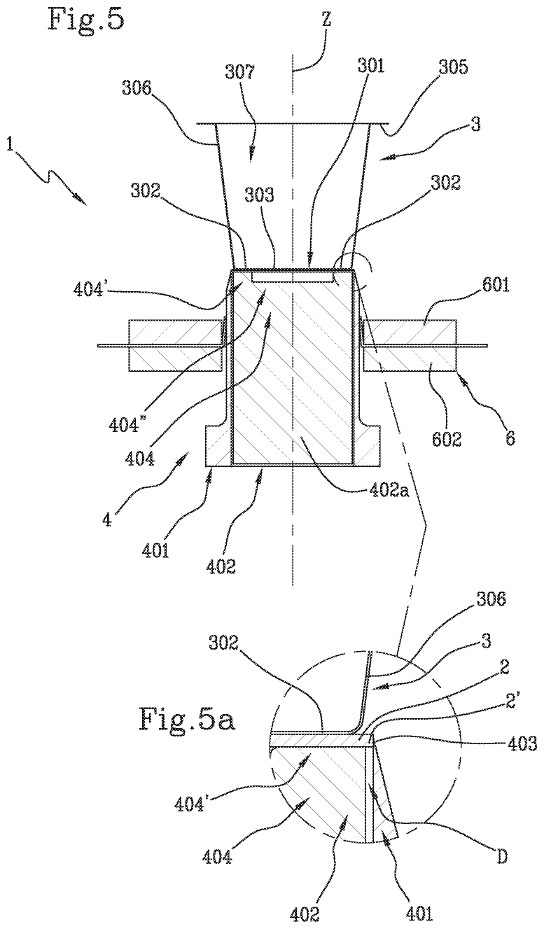

FIG. 5 is a schematic sectional view of the apparatus of FIG. 1, in a cutting step, subsequent to the initial cutting step, in which the operating unit and the container are still in the joined condition and the retaining device is in a cutting position, the sheet element having been cut on the cutting edge during the movement of the retaining device from the tensioning position to the cutting position;

FIG. 5a is a schematic sectional view of an enlargement of the apparatus of FIG. 5, in which the cut sheet element, the joining device and the cutting device are shown;

FIG. 6 is a schematic view of a version of the apparatus of FIGS. 1 to 5a, configured to cut and join a sheet element to both the edge region and an inner region of a base wall of a capsule for beverages, in which the apparatus is in the non-operating step;

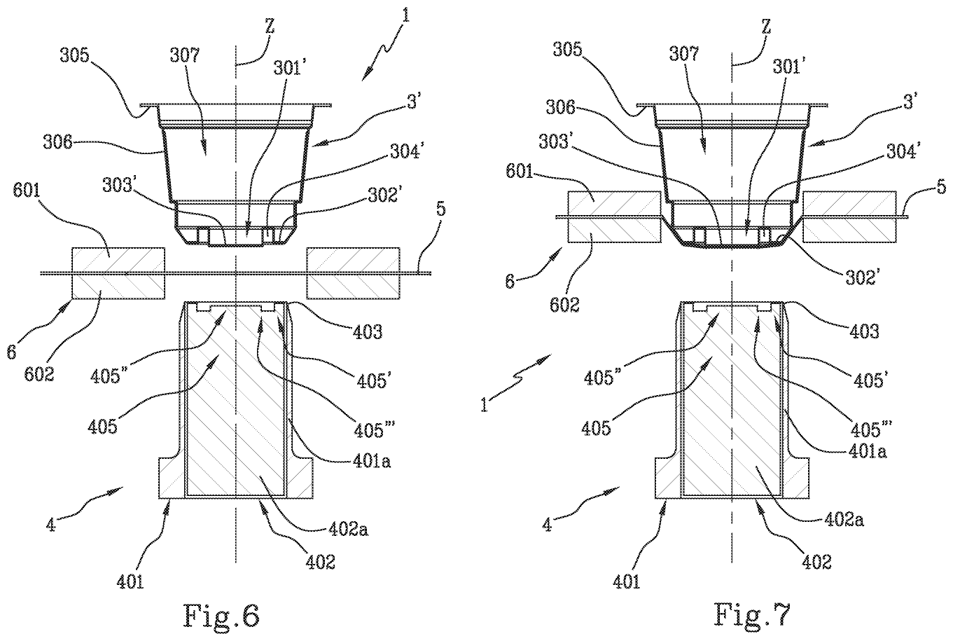

FIG. 7 is a schematic view of the apparatus of FIG. 6, in the preparation step;

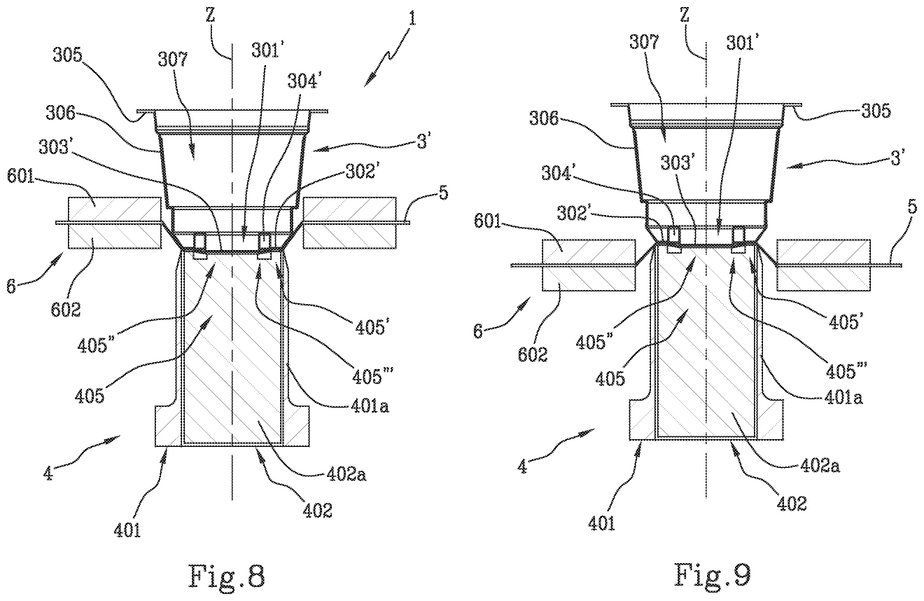

FIG. 8 is a schematic view of the apparatus of FIG. 6, in the joining step;

FIG. 9 is a schematic view of the apparatus of FIG. 6, in the initial cutting step;

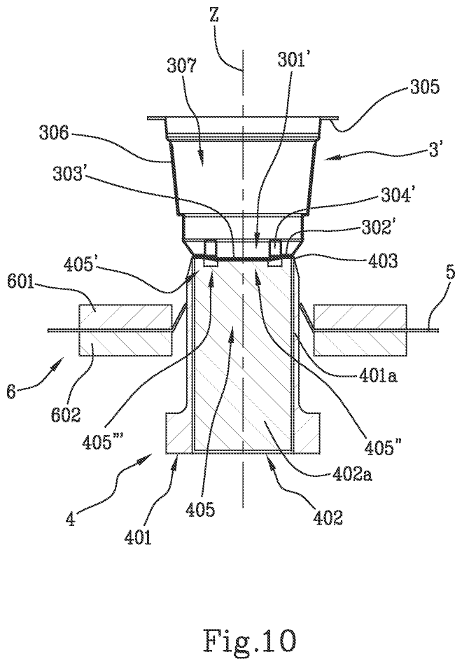

FIG. 10 is a schematic view of the apparatus of FIG. 6, in the cutting step.

In the following description, the same elements are indicated with the same reference numbers in the various figures.

FIGS. 1 to 5 and FIG. 5a show an apparatus 1 for cutting off and joining a sheet element 2 to a container 3.

For example, the apparatus 1 is configured to cut off and join a sheet element 2, as a closing element, to a base wall 301 of a casing of a container 3 such as a capsule for beverages, as well as to cut off and join a sheet element 2, such as a covering element, to a flanged edge 305 of the casing of the capsule 3, to which reference will be made without losing generality.

A capsule for beverages is, in fact, a disposable and single-dose container 3 comprising the casing in the shape of a glass or cup. The casing has the base wall 301 and a side wall 306 defining a cavity 307 which can contain an initial product, not illustrated, for example ground coffee or tea, from which to obtain a final product, not illustrated, by introducing a liquid under pressure, for example water, into the capsule 3.

The flanged edge 305 extends radially from the side wall 306 and is arranged around the cavity 307, on the opposite side with respect to the base wall 301. The cavity 307 can be hermetically closed by a further element, not illustrated, which is the covering element, which can be fixed to the flanged edge 305, so as to seal the initial product inside the container 3.

The base wall 301 of the capsule 3 can have an edge region 302 to which the closing element can be fixed to seal the base wall 301 of the capsule 3 itself, which can delimit an inner region 303, which can be a central opening, not illustrated.

The apparatus 1 comprises an operating unit 4 which in turn comprises a cutting device 401 and a joining device 402.

The cutting device 401 is configured to cut the sheet element 2 from a sheet material 5, the joining device 402 is configured to join the sheet element 2 to the container 3.

Preferably, the sheet material 5 is a continuous web (not illustrated) which is unwound from a reel (not illustrated). However, it is specified that the sheet material 5 could also be a segment of continuous web previously cut which is fed already cut into segments to the apparatus 1, between the operating unit 4 and the container 3.

Sheet material 5 means a flexible film, with a thickness comprised between 0.02 mm and 0.25 mm, for example equal to 0.05 mm, preferably made of aluminium, and/or of a compostable material, for example PLA, and/or or of a biodegradable and/or compostable material other than PLA, and/or paper.

The cutting device 401 comprises a cutting edge 403 which surrounds the joining device 402.

The operating unit 4 and the container 3 are movable with respect to one another along a movement axis Z between:
a spaced condition, in which the sheet material 5 can be interposed between the operating unit 4 and the container 3 and is, in particular, spaced therefrom, and
a joined condition, in which the joining device 402 is configured to join the sheet material 5 to the container 3.

The apparatus 1 further comprises a retaining device 6, configured to retain the sheet material 5 during the joining and the cut.

In the joined condition, the cutting device 401 is configured to remain fixed relative to the joining device 402 and the retaining device 6 is configured to move along the Z axis between a tensioning position and a cutting position, the sheet element 2 being cut on the cutting edge 403 from the sheet material 5 during the movement of the retaining device 6 from the tensioning position to the cutting position.

Thanks to the presence of the retaining device 6, which is movable between the tensioning position and the cutting position, the cutting device 401 and the joining device 402 can remain fixed with respect to one another in the joined condition not only during the joining of the sheet material 5 to the container 3, for example to the base wall 301, but also during the cut of the sheet element 2 from the sheet material 5.

The joining time is therefore increased and, advantageously, by increasing the joining time, also the stability and quality of the join between the sheet element 2 and the container 3, for example between the sheet element 2 and the base wall 301 of the container 3, is increased.

It is added that cutting off is advantageously carried out after joining, when the sheet material 5 has already been joined to the container 3 and this increases the quality of the cutting off itself.

The joining device 402 can be, for example, a heat-sealing or ultrasonic welding device.

In the case of a heat sealing device, by increasing the joining time, it is possible to adjust the heat sealing device to a lower temperature with a consequent improvement of the stability of the weld itself.

In addition, thanks to the fact that the cutting device 401 is fixed and not movable relative to the joining device 402, the container 3 is not damaged during the separation of the sheet element 2 from the sheet material 5 since, when the operating unit 4 and the container 3 are in the joined condition, the cutting edge 403 is kept at a distance from the container 3 itself.

Along the movement axis Z, in the joined condition a joined position is defined in which the sheet material 5 is joined to the container 3.

It should be noted that the movement axis Z is also an axis of symmetry for container 3.

With respect to the joined position, the tensioning position is arranged along the movement axis Z on the side of the container 3, the sheet material 5 being initially moved away from the cutting edge 403 towards the container 3 by the retaining device 6.

Thanks to this, the sheet material 5 is not damaged by the presence of the cutting device 401, since the cutting edge 403 is kept at a distance also from the sheet material 5.

As is evident in FIG. 2, the retaining device 6 in the tensioning position is configured to wrap the sheet material 5 about the base wall 301.

If, in a manner not illustrated, the apparatus 1 is configured to cut off and join the sheet element 2 to a flanged edge 305 of the casing of the capsule 3 to form the covering element, then the retaining device 6 in the retaining position is configured to wrap the sheet material 5 about said flanged edge 305.

Therefore, with respect to the base wall 301 of the container 3, the tensioning position is arranged along the axis Z beyond the base wall 301, on the side of the container 3.

If, as illustrated in FIG. 3, it is the operating unit 4 that moves towards the container 3, which is kept stationary, the joined position corresponds, along the axis Z, to the position of the base wall 301 of the container 3. However, this is not necessary, as we will see later.

Advantageously, during the wrapping about the base wall 301, the retaining device 6 is able to put the sheet material 5 under tension to prevent creases from being created which would damage, as we will see later, the joining of the sheet material 5 to the base wall 301.

With respect to the joined position, the cutting position is arranged along the axis Z on the side of the operating unit 4. It should therefore be noted that the joined position is interposed between the tensioning position and the cutting position. In this way, the retaining device 6 can move starting from the side of the container 3 towards the operating unit 4, to cause the sheet material 5, initially moved away from the cutting edge 403, to intercept the latter to be cut.

If, for example, the movement axis Z is vertical and the operating unit 4 is arranged below the container 3 as shown in FIGS. 1 to 10, the retaining device 6 puts the sheet material 5 under tension in the tensioning position which is far higher than the joined position and lowers (FIGS. 2 and 3) to the cutting position (FIG. 5) to cut the sheet material 5, since the cutting position is far lower than the joined position and the retaining position.

It is specified that what has been said previously may remain valid even if, according to a variant not shown, the operating unit 4 is arranged above the container, or, according to another variant not shown, the movement axis Z is not vertical but, for example, is horizontal.

As shown in FIGS. 1 and 2, the retaining device 6 is configured to move into the tensioning position from a non-operating position, in which the sheet material 5 is retained interposed between the operating unit 4 and the container 3 arranged in the spaced condition, before the operating unit 4 and/or the container 3 move into the joined condition.

In other words, the retaining device 6 is configured to move into the tensioning position in a preparation step that precedes the joining step, in order to wrap the sheet material 5 about the base wall 301 of the container 3 and to put the sheet material 5 under tension.

It should be noted that the cutting device 401 and the joining device 402 are configured to move solidly between the spaced condition and the joined condition.

In other words, the cutting device 401 and the joining device 402 can be fixed to each other and move solidly. Alternatively, the cutting device 401 and the joining device 402 can be movable between them independently but in such a way as to move solidly so that, in the joined condition, they are solidly fixed together.

For this purpose, the apparatus 1 can comprise a movement unit, not illustrated, which can comprise respective movement devices configured to move the cutting device 401 and the joining device 402 solidly between them, or to move independently but solidly respectively the cutting device 401 and the joining device 402 as previously mentioned.

According to an alternative version, not shown, the apparatus 1 can also comprise an abutment device, for example a spindle, which can be configured to be arranged inside the container 3. The abutment device can comprise an abutment head configured to be housed in the cavity 307 so as to engage the side wall 306 and the base wall 301 of the container 3, retaining the container 3 in the joined condition.

In other words, the abutment head can be configured to provide an abutment support to the joining device 402, pushing the base wall 301 towards the joining device 402 in the joined condition when the sheet material 5 is interposed therebetween, to further improve the joining of the sheet material 5 to the base wall 301.

According to a variant not shown, it is the operating unit 4 that remains stationary and it is the container 3 that moves towards the operating unit 4, supported and retained by the abutment device. In this case, the joined position corresponds, along the axis Z, to the position of a head end 404 of the joining device.

The apparatus can comprise a further movement device configured to move the abutment device, when the latter retains the container 3, between the spaced condition and the joined condition.

The apparatus 1 can comprise another movement device for moving the retaining device 6 between the non-operating position, the tensioning position and the cutting position described above.

If it is the operating unit 4 that remains stationary and it is the container 3 that moves towards it in the joined condition, the tensioning device 6 is configured to move into the tensioning position in the preparation step described above, in order to wrap the sheet material 5 about the base wall 301 of the container 3 and put it under tension.

Subsequently, the retaining device 6, arranged in the tensioning position, is configured to move solidly with the container 3, retained and moved by the abutment device, so that the sheet material 5 wrapped about the base wall 301 can contact the joining device 402 in the joined condition.

In this case, the further movement device of the abutment device and the other movement device of the retaining device 6 are configured to move the container 3 and the retaining device 6, respectively, solidly between them.

According to a further variant, not shown, the operating unit 4 and the container 3 can both be movable from the spaced condition to the joined condition, without any of them remaining stationary. In this case, the movement unit of the operating unit 4, the further movement device of the abutment device and the other movement device of the retaining device 6 are configured so as to coordinate the different movements.

The retaining device 6 comprises two plates 601, 602 surrounding the operating unit 4 and the container 3. In detail, the plates 601 and 602 are facing one another, and in particular are annular.

The plates 601, 602 are movable along the movement axis Z between a retained condition, in which they are neared to one another and are configured to retain the sheet material 5, as illustrated in FIGS. 1 to 10, and a moved-away condition (not illustrated) in which they are spaced and the sheet material 5 can be fed between the operating unit 4 and the container 3.

The other movement device can also be configured to move the plates 601, 602 between the moved-away condition and the retained condition.

When the plates 601, 602 are in the retained condition in which they retain the sheet material 5, they are configured to be both movable simultaneously at least between the non-operating position, the tensioning position and the cutting position detailed above.

It should be noted that the joining device 402 comprises a cylindrical body 402a and the cutting device 401 comprises an annular body 401a, arranged concentrically with the cylindrical body 402a.

Between the cylindrical body 402a of the joining device 402 and the annular body 401a of the cutting device 401, as shown in FIG. 5a, there is a distance D which generates an outer flap 2′ not welded in the sheet element 2 which is free, in the sense that it is not joined to the base wall 301.

Advantageously, the distance D can also be reduced to a minimum, or be equal to 0 to keep the cutting device 401 in contact with the joining device 402, so that the outer flap 2′ is as small as possible.

The cylindrical body 402a has a head end 404 configured to engage with the base wall 301 of the container. The head end 404 comprises an outer zone 404′ for example annular, and an inner zone 404′ for example circular, which is surrounded by the outer zone 404′ and is recessed with respect to the outer zone 404′.

The outer zone 404′, for example planar, is configured to join the sheet material 5 to a corresponding edge region 302 of the base wall 301 of the container 3, which lies on a plane.

This plane can be transverse to the movement axis Z, for example perpendicular.

In the joined condition, the outer zone 404′ is configured to abut against said plane and define, along the axis Z, the joined position.

The cutting edge 403 is substantially coplanar with respect to the outer zone 404′.

In other words, as illustrated in FIG. 5a, the cutting edge 403 can project from the outer zone 404′ by a minimum height which is at least equal to the thickness of the sheet material 5 which is to be cut. Since the thickness of the sheet material can also be, as mentioned above, a few hundredths of a mm, i.e. equal to 0.05 mm, the cutting edge 403 can project from the outer zone 404′ by a minimum height, for example equal to 0.05 mm, which does not interfere with the side wall 306 on which the sheet material 5 is to be joined.

However, according to a version not shown, the outer zone 404′ can project with respect to the cutting edge 403. In other words, the cutting edge 403 can be further set back with respect to the outer zone 404′ to further ensure that the cutting edge 403 does not interfere with the side wall 306. In fact, when the retaining device 6 moves from the side of the container 3 towards the operating unit 4 into the cutting position, the sheet material 5 is capable of equally intercepting the cutting edge 403 to cut the sheet element 2 from the sheet material 5, even if the cutting edge 403 is further set back with respect to the outer zone 404′ by a respective further suitable height.

The inner zone 404″ is shaped in such a way as to ensure that, in the inner zone 404″ the sheet material 5 is not joined to the base wall 301 of the container 3 if joining in the corresponding inner region 303 is to be avoided since the opening described above may for example be present.

In the case where the joining device 402 is a heat sealing device, the head end 404 of the cylindrical body 402a is configured to be heated. Therefore, the outer zone 404′ can abut against the edge region 302 of the base wall 301 while, on the contrary, the inner zone 404″ must be distant from a corresponding inner region 303 of the base wall 301 to avoid abutting against it.

As shown in FIGS. 6 to 10, the container 3′ can alternatively also be a capsule for beverages which comprises a cup-shaped casing, which differs from the casing of FIGS. 1 to 5 in that it has a base wall 301′ which is a variant of the base wall 301. The base wall 301′ of the container 3′ is not planar but comprises an edge region 302′ in particular located on a plane, an inner region 303′ located on a further plane, a groove 304′ interposed between the edge region 302′ and the inner region 303′, the inner region 303′ being projecting with respect to the edge region 302′. The base wall 301′ is, in other words, on two levels.

The sheet element 2 must be joined to the edge region 302′ and to the inner region 303′ to realise the closing element of the base wall 301′.

It should therefore be noted that the cylindrical body 402a of the joining device 402 has a head end 405 which differs from the head end 404 of FIGS. 1 to 5 in that it has an outer zone 405′, for example planar, which is configured to join the sheet material 5 to the corresponding edge region 302′ of the base wall 301′ of the container 3′ located on said plane. The head end 405 additionally comprises an inner zone 405″ which is configured to join the sheet material 5 to the inner region 303′ located on the further plane, projecting with respect to said plane.

In this case, both the outer zone 405′ and the inner zone 405″ are configured to abut against the edge region 302′ and the inner region 303′, respectively.

In the joined condition, the joined position is still identified along the movement axis Z by the outer zone 405′ which abuts against the plane on which the edge region 302′ lies.

If the joining device is a heat-sealing device, it should be noted that both the outer zone 405′ and the inner zone 405″ are configured to be heated.

What has been said previously remains valid for what concerns the cutting edge 403, which can project with respect to the outer zone 405′ by a minimum height equal to the thickness of the sheet material 5, or be recessed therefrom by a suitable height. The cutting edge 403 is therefore substantially coplanar with respect to the outer zone 405′.

Between the outer zone 405′ and the inner zone 405″ the head end 405 comprises an annular recess 405′″ which is more recessed than the inner zone 405″ to ensure that in the annular recess 405′″ the sheet element 2 is not joined to the base wall 301′ of the container 3′ and can be arranged inclined between the edge region 302′ and the inner region 303′ so as to cover the groove 304′.

The annular recess 405′″ can be adjacent to the inner zone 405″.

Advantageously, if above all the sheet material 5 is to be joined to the container 3′ having the base wall 301′ with two levels, the retaining device 6 can put the sheet material 5 under tension in the tensioning position to prevent undesired creases in the sheet material 5 itself from occurring, which could jeopardize the correct joining thereof on the edge region 302′ and the inner region 303′.

In accordance with the present invention, a method for cutting off and joining a sheet element 2 to a container is also described, which for example can be the capsule 3 of FIGS. 1 to 5 or the capsule 3′ of FIGS. 6 to 10, which comprises following steps:
providing an operating unit 4 comprising a cutting device 401 and a joining device 402 and providing the cutting device 401 with a cutting edge 403 which surrounds the joining device 402;
moving the operating unit 4 and the container 3, 3′ with respect to one another along a movement axis Z between a spaced condition, in order to interpose between them the sheet material 5, and a joined condition, in order to join the sheet material 5 to the container 3, 3′ in a joining step;
retaining the sheet material 5 during the joining and the cut by means of a retaining device 6; and wherein during the joining step, the method comprises the step of
keeping the cutting device 401 fixed with respect to the joining device 402,
cutting the sheet element 2 from the sheet material 5 on the cutting edge 403 moving the retaining device 6 from a tensioning position to a cutting position in a cutting step.

The joining step therefore precedes the cutting step but does not stop during the cutting step, which is performed within the joining step. The latter can be as long as possible and guarantee, as already detailed above, a more stable and precise joining of the sheet element 2 to a base wall 301, 301′ of the container 3, 3′.

Thanks to the step of keeping the cutting device 401 fixed during the joining step, any interaction between the cutting edge 403 and the container 3, 3′ is avoided.

Along the movement axis Z, the joined condition defines a joined position in which the sheet material 5 is joined to the container 3, 3′.

The method further comprises the step of arranging the retaining device 6 on the side of the container 3, 3′ with respect to the joined position, in a preparation step, to move the sheet material 5 away from the cutting edge 403 before the cutting step and to wrap the sheet material 5 about the wall of the container 3, 3′. The retaining device 6 can thus be moved into the tensioning position.

This allows the sheet material 5 to be put under tension so as to avoid unwanted creases from occurring during the subsequent joining step and at the same time ensures that the sheet material 5 is not cut by the cutting edge 403 during the joining step of the sheet material 5 itself.

The step of moving the retaining device 6 into the tensioning position comprises moving the sheet material 5 from the side of the container 3, 3′ and wrapping the sheet material 5 about a base wall 301, 301′ of the container 3, 3′.

The step of moving the retaining device 6 into the cutting position comprises moving the sheet material 5 from the side of the operating unit 4 with respect to the joined position so that the retaining device 6 moves the sheet material 5 from the side of the container 3, 3′ to the side of the operating unit 4, in order to cut the sheet material 5.

The method further comprises the step of arranging the retaining device 6 in a non-operating position to retain the sheet material 5 interposed between the operating unit 4 and the container 3; 3′ and moving the retaining device 6 from the non-operating position to the tensioning position when the operating unit 4 and the container 3, 3′ are in the spaced condition.

In other words, the method provides the preparation step, which precedes the joining step when the operating unit 4 and the container 3, 3′ are still in the spaced condition, in which the retaining device 6 prepares the sheet material 5, by tensioning it around the base wall 301, 301′ of the container 3, 3′ moving from the non-operating position to the tensioning position.

The joining step comprises providing a head end 404, 405 provided with an outer zone 404′, 405′ and with an inner zone 404″ 405″ surrounded by the outer zone 404′ 405′, with a cylindrical body 402a of the joining device 402 and defining the joined position by means of the outer zone 404′, 405′ which joins the sheet material to an edge region 302, 302′ of a base wall 301, 301′ of the container 3, 3′ located on a plane and optionally joining the sheet material 5 also to the inner region 303′ located on a further plane, by means of the inner zone 405″.

It should therefore be noted that the method of the present invention provides joining the closing element to the edge region 302, 302′ of the base wall 301, 301′ located on said plane and optionally the step of joining the closing element also to the inner region 303′ of the base wall 301 located on the further plane.

The method of the present invention can also be advantageously used to cut off and join a covering element, not illustrated, to a flanged edge 305 of the casing of a capsule 3, 3′ for beverages.

In other words, this method can be advantageously used to join a sheet element 2 to the capsule 3, 3′ in which the sheet element 2 can be a covering element to be joined to the flanged edge 305 or a closing element to be joined to the base wall 301, 301′.

In use, if we now consider FIGS. 1 to 5 and FIGS. 6 to 10, we are going to list in sequence the operation of the apparatus 1 and the relative steps of the method described above.

In the non-operating step of FIG. 1 and FIG. 6, the container 3, 3′ and the operating unit 4 are in the spaced condition and, after the sheet material 5 has been fed between them, the plates 601, 602 of the retaining device 6 which were in the moved-away condition, move into the retaining condition to retain between them the sheet material 5. In the retaining condition, the retaining device 6, i.e. the plates 601, 602 which retain the sheet material 5, are arranged in the non-operating position to retain the sheet material 5 interposed between the operating unit 4 and the container 3, 3′.

Subsequently, in the preparation step of FIG. 2 and FIG. 7, the container 3, 3′ and the operating unit 4 are still in the spaced condition, but the retaining device 6 has moved along the movement axis Z into the tensioning position, beyond the base wall 301, 301′ of the container 3, 3′ to wrap the sheet material 5 about the base wall 301, 301′ and to put the sheet material 5 itself under tension.

Subsequently, in the joining step of FIG. 3 and FIG. 8, the operating unit 4, i.e. the cutting device 401 and the joining device 402, move solidly towards the container 3, 3′ in the joined condition and the joining device 402 joins the sheet material 5 to the container 3, 3′. While the operating unit 4 is in the joined condition, the retaining device 6 is still in the tensioning position to move the sheet material 5 away from the cutting edge 403 of the cutting device 401.

In detail, the outer zone 404, 405′ of the head end 404, 405 of the joining device 402, joins the sheet material 5 to the edge region 302, 302′ of the capsule 3, 3′ for example by abutting against it and defining the joined position along the movement axis Z.

In FIG. 3, the inner zone 404″ is recessed and ensures that, in the inner zone 404″ the sheet material 5 is not joined to the base wall 301 of the container.

In FIG. 8, the inner zone 405″ joins the sheet material 5 to the inner region 303′ of the base wall 301′ of the container 3′ located on a further plane.

Subsequently, in the cutting step of FIGS. 4, 5 and 9, 10, while the operating unit 4 is still in the joined condition, the retaining device 6 moves from the tensioning position to the cutting position to ensure that the sheet material 5 initially intercepts the cutting edge 403 of the cutting device 401, as shown in FIGS. 4 and 9, and subsequently cuts the sheet element 2 from the sheet material 5, as shown in FIGS. 5 and 10.

It should therefore be noted that the apparatus and the method in accordance with the present invention allow a sheet element 2 to be cut off and joined from a sheet material 5 in a simple and economical way ensuring high quality of the container 3, 3′ resulting therefrom. The joining step precedes the cutting step and this guarantees a longer duration of the joining time and a cut off of the sheet material 5 when the sheet material 5 is already joined to the container 3, 3′ with a consequent guarantee that the joining and the subsequent cut off is performed without defects.

It may also be advantageously possible to provide a machine, not illustrated, which comprises a plurality of welding and cutting off apparatuses as described above. The machine can be configured to cut off and join sheet elements 2 to respective containers 3, 3′ which can still be joined together and obtained by thermoforming a suitable further sheet material.

The machine can comprise a plurality of operating units 4, each associated with the respective container 3, 3′ which can for example be joined together solidly and moved simultaneously by the movement unit. The machine can also comprise a pair of platters provided with a plurality of through openings suitably sized, each associated with the respective container 3, 3′ in which an annular portion, which defines a relative retaining device 6, is defined around each opening. The pair of platters can be moved by the other movement device to simultaneously move the plurality of retaining devices 6 between the tensioning position and the cutting position.

In this way, in a simple and effective way, it is possible to have a machine capable of cutting off and joining a plurality of sheet elements to respective containers 3, 3′.

1. An apparatus for cutting off and joining a sheet element to a container, the apparatus comprising:
an operating unit comprising a cutting device and a joining device, wherein the cutting device comprises a cutting edge which surrounds the joining device; wherein
the operating unit and the container are movable with respect to one another along a movement axis between a spaced condition, in which a sheet material is interposed therebetween and is spaced therefrom, and a joined condition, in which the joining device) is configured to join the sheet material to the container; wherein the apparatus additionally comprises:
a retaining device, configured to retain the sheet material during the joining and the cut; and wherein the apparatus is characterised in that in the joined condition
the cutting device is configured to remain fixed relative to the joining device, and
the retaining device is configured to move along the axis from a tensioning position to a cutting position, the sheet element being cut on the cutting edge from the sheet material during the movement of the retaining device from the tensioning position to the cutting position.

2. The apparatus according to claim 1, wherein the tensioning position is arranged along the axis on the side of the container, the sheet material being moved away from the cutting edge towards the container in the tensioning position.

3. The apparatus according to claim 2, wherein the container has a base wall on which the sheet element is to be joined, the retaining device being configured to wrap the sheet material about the base wall when it is in the tensioning position.

4. The apparatus according to claim 1, wherein in the joined condition a joined position is defined in which the sheet material is joined to the container, and wherein the cutting position is arranged along the axis on the side of the operating unit, the joined position being interposed between the tensioning position and the cutting position so that the retaining device moves the sheet material from the container side towards the operating unit in order to cut the sheet material and obtain the cut sheet element.

5. The apparatus according to claim 1, wherein when the operating unit and the container are in the spaced condition and before the operating unit and the container move into the joined condition, the retaining device is configured to move into the tensioning position from a non-operating position, configured to retain the sheet material interposed between the operating unit and the container and spaced therefrom.

6. The apparatus according to claim 1, wherein the cutting device and the joining device are configured to move solidly between the spaced condition and the joined condition.

7. The apparatus according to claim 1, wherein the retaining device comprises a pair of plates surrounding the operating unit and the container, which are facing one another and, in particular, are annular.

8. The apparatus according to claim 7, wherein the plates are movable along the axis between a retained condition, in which they are neared and are configured to retain the sheet material during the joining step and cutting step, and a moved-away condition in which they are spaced and the sheet material can be fed between the operating unit and the container.

9. The apparatus according to claim 1, wherein the joining device comprises a cylindrical body and the cutting device comprises an annular body arranged concentrically to the cylindrical body.

10. The apparatus according to claim 9, wherein the cylindrical body comprises a head end provided with an outer zone, for example annular, and an inner zone, for example circular, which is surrounded by the outer zone, and is recessed with respect to the outer zone, wherein the outer zone is configured to join the sheet material to an edge region of the base wall of the container, which is positioned on a plane.

11. The apparatus according to claim 10, wherein the cutting edge projects from the outer zone by a height equal to a thickness of the sheet material.

12. The apparatus according to claim 10, wherein the inner zone is shaped to prevent joining the sheet material to an inner region of the base wall of the container.

13. The apparatus according to claim 11, wherein the inner zone is configured to join the sheet material to an inner region of the base wall of the container, which is positioned on a further plane, projecting with respect to said plane.

14. The apparatus according to claim 13, wherein between the outer zone and the inner zone the head end comprises an annular recess, more recessed with respect to the inner zone, which is shaped to prevent joining the sheet material to the base wall of the container.

15. A method for cutting off and joining a sheet element to a container, which comprises following steps
providing an operating unit comprising a joining device and a cutting device, wherein the cutting device comprises a cutting edge which surrounds the joining device;
moving the operating unit and the container with respect to one another along a movement axis between a spaced condition, in order to interpose between them, spaced, the sheet material, and a joined condition, in order to join the sheet material to the container, in a joining step;
retaining the sheet material during the joining and the cut by means of a retaining device; the method being characterised in that in the joined condition, it comprises the step of
maintaining the cutting device fixed with respect to the joining device,
cutting the sheet element from the sheet material on the cutting edge by moving the retaining device from a tensioning position to a cutting position in a cutting step.

16. The method according to claim 15, and comprising a step of arranging the retaining device in the tensioning position, on the side of the container with respect to the joined condition, in a preparation step, to move the sheet material away from the cutting edge before the cutting step and to wrap the sheet material around a base wall of the container.

17. The method according to claim 15, wherein moving the retaining device towards the cutting position comprises defining a joined position in which the sheet material is joined to the container, moving the sheet material from the side of the operating unit with respect to the joined position, so that the retaining device moves the sheet material from the side of the container towards the operating unit, in order to cut the sheet material.

18. The method according to claim 15, and comprising the step of arranging the retaining device in a non-operating position in order to retain the sheet material interposed between the operating unit and the container and of moving the retaining device from the non-operating position to the tensioning position when the operating unit and the container are in the spaced condition.

19. The method according to claim 15, wherein the sheet element is a closing element for closing a base wall of a cup-shaped casing of a capsule for beverages and the method comprises the step of joining the sheet material to an edge region of the base wall in particular located on a plane and subsequently cutting the sheet element from the sheet material.

20. The method according to claim 19, and wherein the method comprises a step of joining the sheet material also to an inner region of the base wall located on a further plane.

21. The method according to claim 15, wherein the sheet element is a
covering element for covering a flanged edge of a cup-shaped casing of a capsule for beverages and the method comprises the step of joining the sheet material to the flanged edge.
